(19) United States
(12) Patent Application Publication
(10) Pub. No.: US 2025/0382028 A1
(43) Pub. Date: Dec. 18, 2025

(54) DISPLAY MOUNT FOR SNOWMOBILE

(71) Applicant: Textron Inc., Providence, RI (US)

(72) Inventors: Zachary Pritchard, Providence, RI (US); Jacob Tyler Crosby, Providence, RI (US)

(73) Assignee: Textron Inc., Providence, RI (US)

(21) Appl. No.: 18/743,932

(22) Filed: Jun. 14, 2024

(51) Int. Cl. B62J 50/21; B62M 27/00

(52) U.S. Cl. CPC B62J 50/225; B62M 27/00

(57) ABSTRACT

A mounting assembly for coupling a display device to a snowmobile includes a base and a cover pivotably coupled to the base. The base is configured to couple to a body component of the snowmobile. The base defines a cavity configured to receive the display device. The cover is configured to pivot between an open position and a closed position. The cover defines an aperture configured to align with a display of the display device when the cover is in the closed position. The cover is configured to cover a portion of the display device when in the closed position such that the display device is disposed between the base and the cover.

### BACKGROUND

The present application relates to a display mount for a vehicle. More specifically, the present application relates to a display mount for a snowmobile.

### SUMMARY

One embodiment relates to a mounting assembly for coupling a display device to a snowmobile. The mounting assembly includes a base and a cover pivotably coupled to the base. The base is configured to couple to a body component of the snowmobile. The base defines a cavity configured to receive the display device. The cover is configured to pivot between an open position and a closed position. The cover defines an aperture configured to align with a display of the display device when the cover is in the closed position. The cover is configured to cover a portion of the display device when in the closed position such that the display device is disposed between the base and the cover.

Another embodiment relates to a snowmobile. The snowmobile includes a frame, a body coupled to the frame, and a mounting assembly. An upward facing surface of the body defines a mounting interface. The mounting assembly is disposed along the mounting interface. The mounting assembly is configured to receive a display device. The mounting assembly extends upward from the mounting interface such that a display of the display device is positioned above the upward facing surface of the body when the display device is received by the mounting assembly.

Still another embodiment relates to a mounting assembly for coupling a display device to a vehicle. The mounting assembly includes a base and a cover coupled to the base. The base is configured to couple to a body component of the vehicle. The base defines a cavity configured to receive the display device. The cover defines an aperture configured to align with a display of the display device when the display device is received by the mounting assembly. An edge of the aperture is configured to be flush with the display such that material deposited on the display sheds off of the display. A peripheral wall of the cover extending from the edge extends therefrom at a downward sloping angle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a front view of a vehicle, according to an exemplary embodiment.

FIG. 2 is a rear view of the vehicle of FIG. 1, according to an exemplary embodiment.

FIG. 3 is a side view of the vehicle of FIG. 1, according to an exemplary embodiment.

FIG. 4 is another side view of the vehicle of FIG. 1, according to an exemplary embodiment.

FIG. 5 is a top view of the vehicle of FIG. 1, according to an exemplary embodiment.

FIG. 6 is a schematic block diagram of the vehicle of FIG. 1, according to an exemplary embodiment.

FIG. 7 is a detailed perspective view a portion of the vehicle of FIG. 1, according to an exemplary embodiment.

FIG. 8 is a perspective view of a hood assembly of the vehicle of FIG. 1, according to an exemplary embodiment.

FIG. 9 is a detailed top perspective view the hood assembly of FIG. 8, according to an exemplary embodiment.

FIG. 10 is another detailed perspective view of the hood assembly of FIG. 8, according to an exemplary embodiment.

FIG. 11 is a detailed bottom view the hood assembly of FIG. 8, according to an exemplary embodiment.

FIG. 12 is a perspective view of a display mount assembly of the hood assembly of FIG. 8 with a display supported thereby, according to an exemplary embodiment.

FIG. 13 is a bottom view of the display mount assembly of FIG. 12, according to an exemplary embodiment.

FIG. 14 is a perspective view of the display mount assembly of FIG. 12, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle of the present disclosure includes a mounting assembly configured to facilitate mounting a display device with the vehicle. The mounting assembly may be coupled to a body of the vehicle and include a display device coupled therewith. The display device may be or include a display to facilitate displaying information corresponding to the operation of the vehicle to an operator of the vehicle. The mounting assembly may include a first body or first body assembly configured to couple to the body of the vehicle and a second body or second body assembly pivotably coupled to the first body or first body. The first body may define a cavity configured to receive the display device. The mounting assembly may be placed in a first configuration where the mounting assembly is configured to receive the display device in the cavity of the first body and a second configuration where the second body is configured to cover a portion of the display device such that the display device is coupled to the mounting assembly between the first body and the second body. An upward facing surface of the second body may be flush with the display of the display device such that material deposited on the display is shed off of the display toward the upward facing surface of the second body. The body of the vehicle may include a compartment configured to receive and support miscellaneous items and gear associated with the vehicle. When the mounting assembly is in the second configuration, the second body may cover the compartment such that access into and out of the compartment is restricted.

### Overall Vehicle

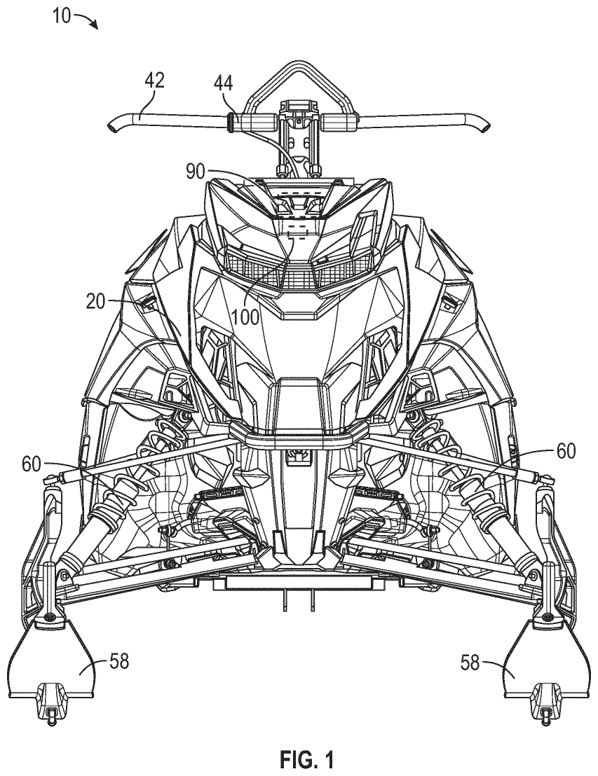

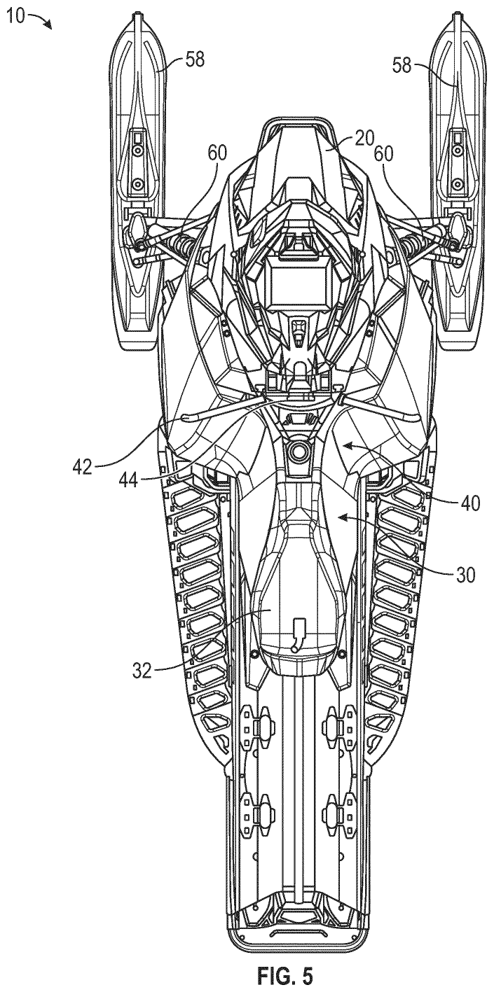

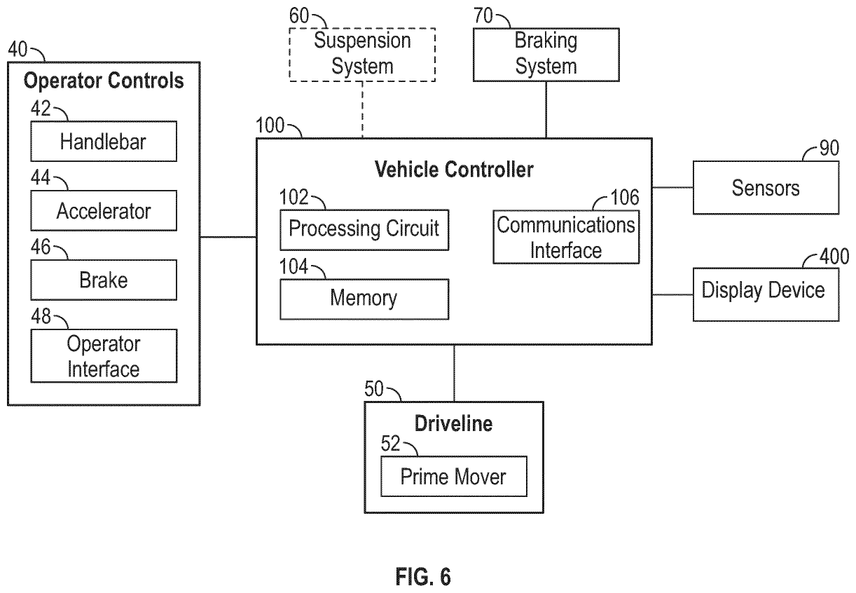

As shown in FIGS. 1-6, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is a tracked, winter-focused off-road machine or vehicle (e.g., a tracked vehicle, etc.) configured to be operated on a snowy and/or icy surface (e.g., operated in snow, on ice, etc.). In some embodiments, the tracked, winter-focused off-road machine or vehicle is a lightweight or recreational machine or vehicle such as a snowmobile, a snow bike, a snow scooter, a snow all-terrain vehicle (“ATV”), a snow utility task vehicle (“UTV”), a snow plow machine, and/or another type of lightweight or recreational machine configured to be operated on a snowy and/or icy surface. In other embodiments, the tracked, snow-focused off-road machine or vehicle is a large machine or vehicle such as a snowcat, a snow groomer, a snow plow machine, a tractor, and/or another type of large machine or vehicle configured to be operated on a snowy and/or icy surface. In still other embodiments, the vehicle 10 is a non-tracked, off-road machine or vehicle such as an ATV, a UTV, a dirt bike, and/or another type of non-tracked, off-road machine or vehicle.

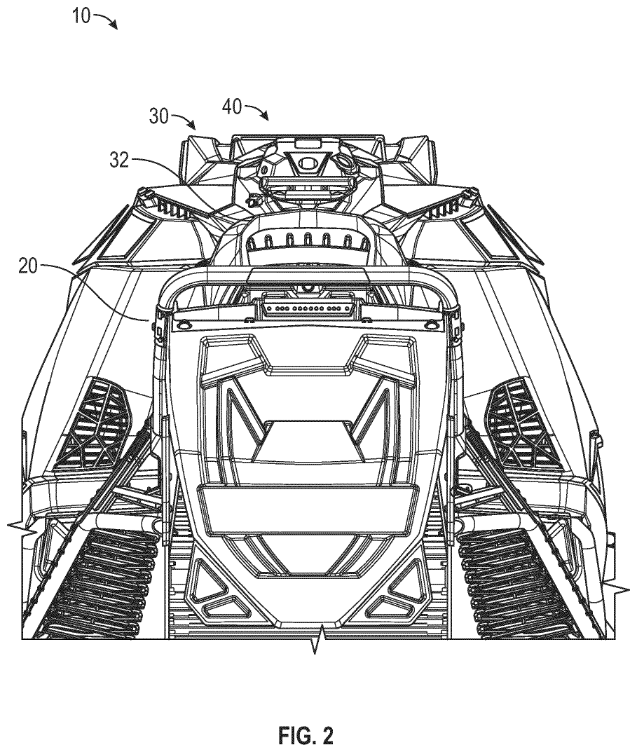

According to the exemplary embodiment shown in FIGS. 2-5, the occupant seating area 30 includes a first seat, shown as operator seat 32, configured to support an operator of the vehicle 10. In some embodiments, the occupant seating area 30 includes a double seat configured to support the operator of the vehicle 10 and a passenger of the vehicle 10 behind the operator, or a triple seat configured to support the operator of the vehicle 10 and two passengers of the vehicle 10 behind the operator. In some embodiments, the occupant seating area 30 includes a second seat positioned rearward of or to the side of the operator seat 32. The second seat may be configured to support passengers of the vehicle 10. In some embodiments, in addition to or in place of the second seat, the vehicle 10 includes one or more rear accessories. Such rear accessories may include a ski rack, a bed, a cargo body (e.g., for storage, etc.), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1-6, the operator controls 40 include a steering interface (e.g., a handlebar, a steering column, a handlebar assembly, joystick(s), a steering wheel, etc.), shown as handlebar 42, an accelerator interface (e.g., a pedal, a throttle, a throttle lever, etc.), shown as accelerator 44, a braking interface (e.g., a brake pedal, a brake lever, a brake arm, etc.), shown as brake 46, and one or more additional interfaces (e.g., a light control interface, an operational mode interface, etc.), shown as operator interfaces 48. The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

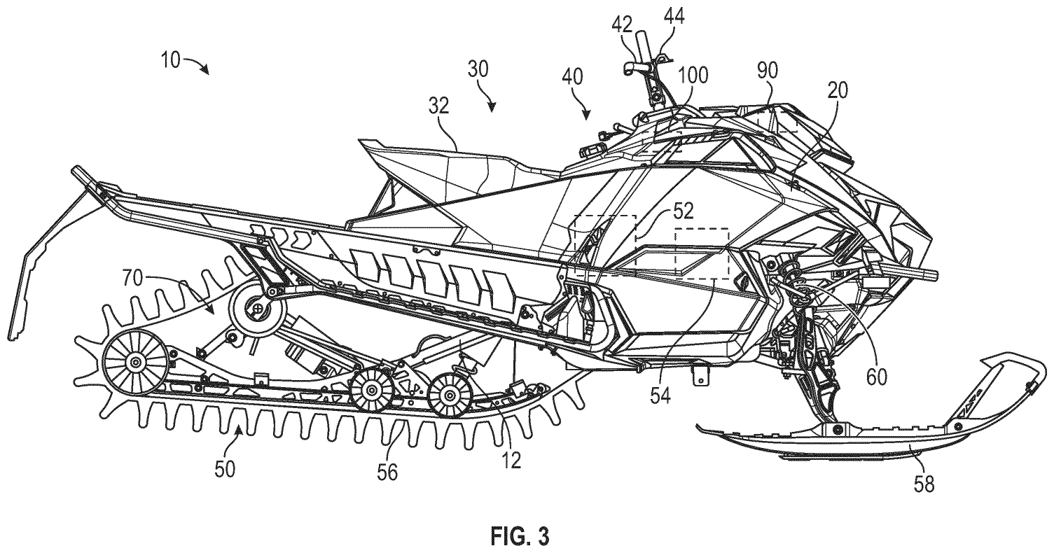

According to an exemplary embodiment, the driveline 50 is configured to propel the vehicle 10. As shown in FIGS. 3, 4, and 6, the driveline 50 includes a primary driver, shown as prime mover 52, an energy storage device, shown as energy storage 54, a first tractive assembly (e.g., tracks, treads, axles, differentials, etc.), shown as rear tractive assembly 56, and a second tractive assembly (e.g., skis, runners, slides, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

According to the exemplary embodiment shown in FIGS. 1-5, the rear tractive assembly 56 includes a rear tractive element that is configured as a track and the front tractive assembly 58 includes front tractive elements configured as skis. For example, the rear tractive element may be configured as a track configured to engage a snowy surface in order to drive the vehicle 10 and the front skis may be configured to slide or glide along the snowy surface. In some embodiments, the rear tractive assembly 56 includes a plurality of the rear tractive elements configured as tracks. In some embodiments, the front tractive assembly 58 includes front tractive elements that are configured as tracks. In other embodiments, the front tractive assembly 58 and the rear tractive assembly 56 include tractive elements that are configured as wheels.

According to an exemplary embodiment, the prime mover 52 is configured to provide power to drive the rear tractive assembly 56 (e.g., to provide rear-track drive, etc.). In some embodiments, the prime mover 52 is configured to provide power to drive the rear tractive assembly 56 and/or the front tractive assembly 58 (e.g., to provide front-track drive, to provide all-track drive, etc.). In some embodiments, the driveline 50 includes a transmission device (e.g., a gearbox, a continuous variable transmission (“CVT”), etc.) positioned between (a) the prime mover 52 and (b) the rear tractive assembly 56. In a non-track arrangement, the rear tractive assembly 56 may include a drive shaft, a differential, and/or an axle. In such non-track arrangement, the rear tractive assembly 56 may include two axles or a tandem axle arrangement. According to an exemplary embodiment, the front tractive assembly 58 is steerable (e.g., using the handlebar 42). In some embodiments, the rear tractive assembly 56 is additionally or alternatively steerable. In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first of the prime movers 52 that drives a first one of the rear tractive elements and a second of the prime movers 52 that drives a second one of the rear tractive elements when the rear tractive assembly 56 includes two rear tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include one or more rear braking components positioned to facilitate braking one or more components of the rear tractive assembly 56 (e.g., the rear axle, the rear tractive elements, etc.). In some embodiments (e.g., embodiments with two rear tractive elements), the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), suspension sensor(s), wheel/track sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the handlebar 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Display Mounting Assembly

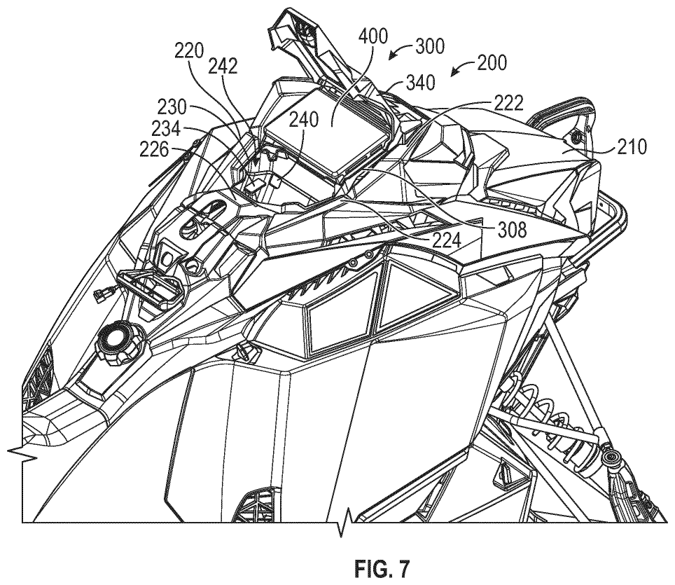

As shown in FIG. 7, the body 20 includes a hood (e.g., a front portion, a hood panel assembly, a front assembly etc.), shown as hood assembly 200, positioned at a forward end of the body 20. The hood assembly 200 and the frame 12 may collectively define a hood compartment (e.g., a hood opening, a forward compartment, an engine compartment, etc.). The prime mover 52 and/or the energy storage 54 may be positioned in the hood compartment defined by the hood assembly 200 and the frame 12. In some embodiments, the hood assembly 200 is configured to reduce air resistance of the vehicle 10 in a longitudinal direction of the vehicle 10 (e.g., in a direction extending between a forward end of the vehicle 10 and a rearward end of the vehicle 10, in a direction opposition a direction of travel of the vehicle 10, etc.). The hood assembly 200 may be removably and/or pivotably coupled to a remainder of the body 20 and/or the frame 12. By way of example, the hood assembly 200 may be removed from or pivoted relative to the remainder of the body 20 and/or the frame 12 to inspect elements positioned in the hood compartment (e.g., the prime mover 52, the energy storage 54, etc.).

As shown in FIG. 7, the hood assembly 200 includes a front portion (e.g., a nose, etc.), shown as hood nose 210, positioned at the forward end of the body 20 and a top portion (e.g., a cover, a dashboard, etc.), shown as hood cover 220, coupled to the hood nose 210 and positioned at least partially rearward of the hood nose 210 in the longitudinal direction. The hood nose 210 may be coupled to a forward end of the frame 12. In some embodiments, the hood nose 210 and the hood cover 220 are coupled by a snap fit connection. In other embodiments, the hood nose 210 and the hood cover are otherwise coupled together (e.g., fastened, adhesively coupled, etc.). In still other embodiments, the hood nose 210 and the hood cover 220 are integrally formed (e.g., from a single piece of plastic, etc.).

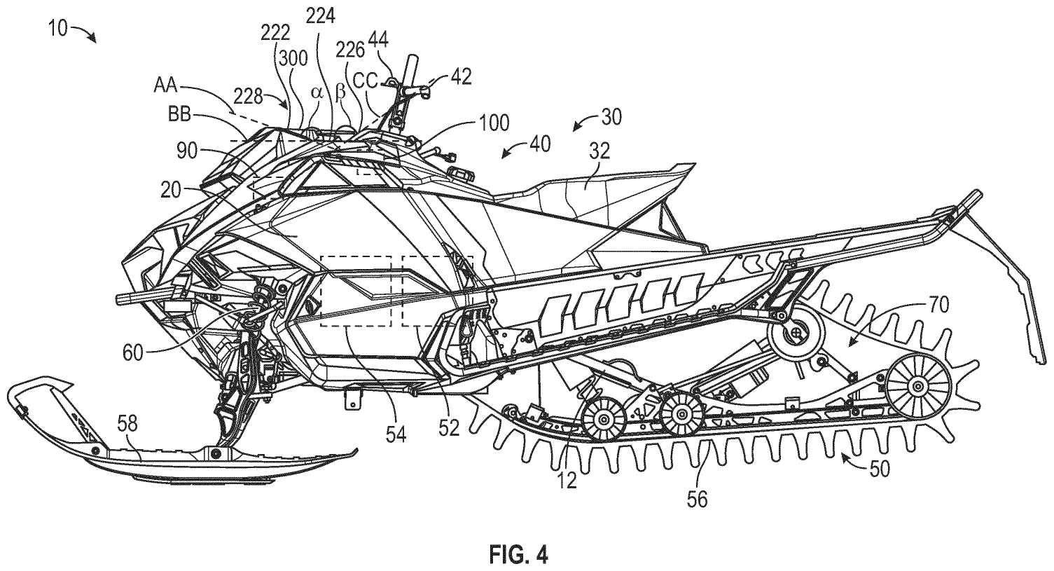

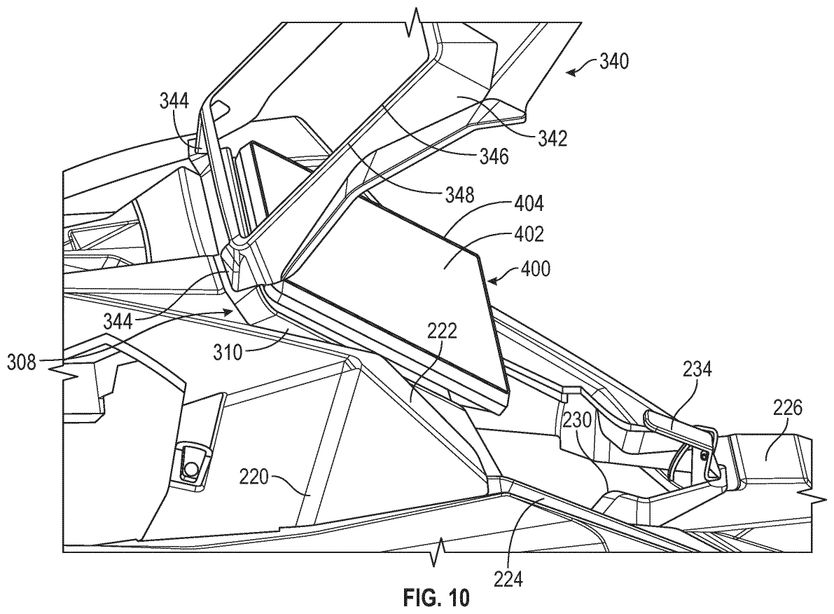

As shown in FIGS. 4 and 7-10, an upper surface (e.g., an upward facing surface, a top surface, etc.) of the hood cover 220 includes a first surface (e.g., a downward angled surface, a first inclined surface, etc.), shown as forward surface 222, positioned at a forward end of the hood cover 220, a second surface (e.g., a flat surface, a trough surface, etc.), shown as intermediate surface 224, positioned rearward of the forward surface 222, and a rear surface (e.g., an upward angled surface, a second inclined surface, etc.), shown as rearward surface 226, positioned rearward of the forward surface 222 and the intermediate surface 224. The forward surface 222 and the rearward surface 226 may each be contiguous with the intermediate surface 224. A rearward edge of the forward surface 222 may be contiguous with a forward edge of the intermediate surface 224 and a rearward edge of the intermediate surface 224 may be contiguous with a forward edge of the rearward surface 226. In some embodiments, the hood cover 220 is formed from one or more bent, curved, angled, formed, etc. sections (e.g., one or more pieces of materiel, one or more members formed together, etc.) to define the forward surface 222, the intermediate surface 224, and the rearward surface 226.

As shown in FIG. 4, the forward surface 222 defines a first plane (e.g., a downward plane, etc.), shown as plane AA, extending along the forward surface 222. In some embodiments, a forward edge of the forward surface 222 may be positioned above the rearward edge of the forward surface 222 such that a first portion of the plane AA proximate the forward edge of the forward surface 222 is positioned above a second portion of the plane AA proximate the rearward edge of the forward surface 222 (e.g., the plane AA is angled downward towards the rearward end of the vehicle 10, the plane AA is angled downward in a direction opposite the direction of travel of the vehicle 10, etc.).

As shown in FIG. 4, the intermediate surface 224 defines a second plane, shown as plane BB, extending along the intermediate surface 224. The intermediate surface 224 is angled relative to the forward surface 222 such that the plane BB is angularly offset from the plane AA by an angle α that is less than 180 degrees. In some embodiments, the angle α is greater than 90 degrees. In some embodiments, the forward edge of the intermediate surface 224 may be positioned level with the rearward edge of the intermediate surface 224 such that a first portion of the plane BB proximate the forward edge of the intermediate surface 224 is level with a second portion of the plane BB proximate the intermediate surface 224 (e.g., the plane BB is parallel to the direction of travel of the vehicle 10, etc.).

As shown in FIG. 4, the rearward surface 226 defines a third plane, shown as plane CC, extending along the rearward surface 226. The rearward surface 226 is angled relative to the intermediate surface 224 such that the plane CC is angularly offset from the plane BB by an angle β that is less than 180 degrees. In some embodiments, the angle β is greater than 90 degrees. In various embodiments, the plane CC is perpendicular to the plane AA. In some embodiments, the forward edge of the rearward surface 226 may be positioned below a rearward edge of the rearward surface 226 such that a first portion of the plane CC proximate the forward edge of the rearward surface 226 is positioned below a second portion of the plane CC proximate the rearward edge of the rearward surface 226 (e.g., the plane is angled upward toward the rearward end of the vehicle 10, the plane CC is angled upward in the direction opposite the direction of travel of the vehicle 10, etc.).

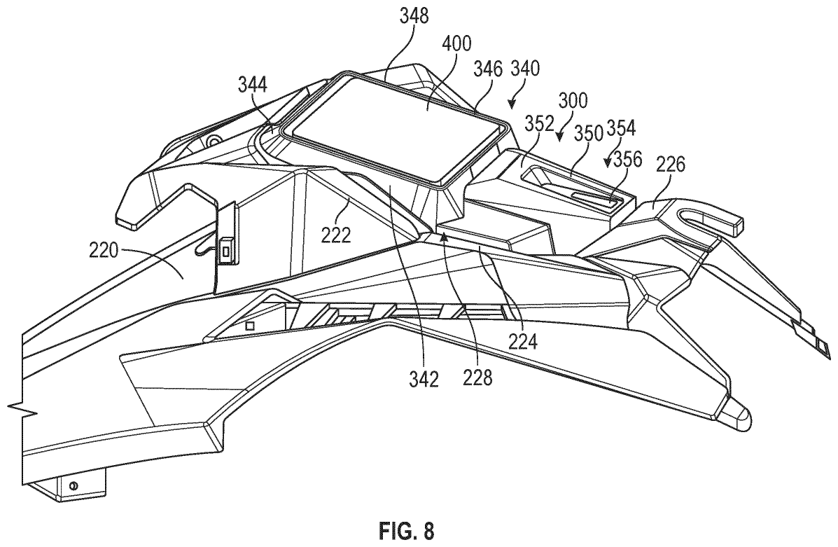

As shown in FIGS. 4 and 8, the forward surface 222, the intermediate surface 224, and the rearward surface 226 collectively define a trough (e.g., a valley, a recess, a cavity, a divot, etc.) in the hood cover 220, shown as hood trough 228, positioned within the upper surface of the hood cover 220. The hood trough 228 may be a cavity in the top surface of the hood cover 220 cooperatively defined by the plane AA, the plane BB, and the plane CC and between opposing sides of the hood trough 228 (e.g., the forward surface 222, the intermediate surface 224, and the rearward surface 226 on opposing sides of the hood trough 228). In other embodiments, the forward surface 222 and the rearward surface 226 collectively define the hood trough 228 (e.g., in embodiments of the hood cover 220 that do not include the intermediate surface 224. The hood trough 228 may be a cavity in the top surface of the hood cover 220 cooperatively defined by the plane AA and the plane CC that is positioned above the plane AA and the plane CC. In still other embodiments, the forward surface 222 and the intermediate surface 224 or the intermediate surface 224 and the rearward surface 226 define the hood trough 228.

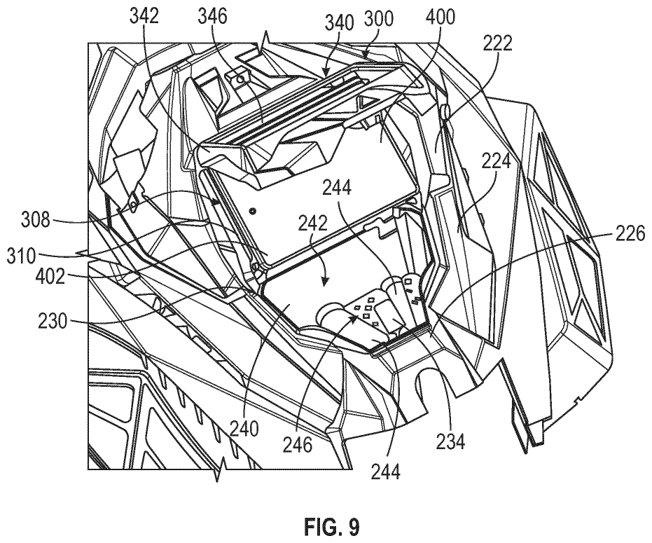

As shown in FIGS. 7 and 9-11, the hood cover 220 defines a first aperture (e.g., a first hole, a first slot, an aperture, a recess, etc.), shown as tray aperture 230, extending through the hood cover 220. The tray aperture 230 may provide access into the hood compartment of the vehicle 10 through the hood cover 220. As shown in FIG. 9, the tray aperture 230 extends through a portion of the intermediate surface 224 and the rearward surface 226 of the hood cover 220. In various embodiments, the tray aperture 230 extends through at least one of the forward surface 222, the intermediate surface 224, or the rearward surface 226.

As shown in FIGS. 7 and 9-11, the hood cover 220 includes a latch member (e.g., a latch extrusion, a latch post, etc.), shown as tray latch member 234, configured to be engaged by a latch assembly (e.g., a latch, a latch mechanism, etc.). The tray latch member 234 may extend in the longitudinal direction over the tray aperture 230. In other embodiments, the tray latch member 234 extends in a lateral direction (e.g., perpendicular to the longitudinal direction, etc.) over the tray aperture 230. As shown in FIG. 9, the tray latch member 234 extends from the rearward surface 226. In other embodiments, the tray latch member 234 extends from the intermediate surface 224 or the forward surface 222. In other embodiments, the hood cover 220 does not include the tray latch member 234.

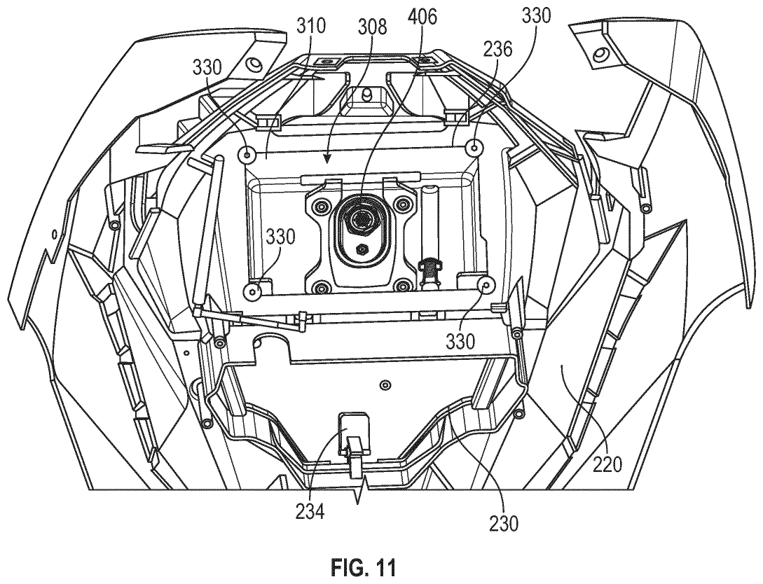

As shown in FIG. 11, the hood cover 220 defines a second aperture, shown as mounting aperture 236, extending through the hood cover 220 and positioned forward of the tray aperture 230. The mounting aperture 236 may provide access into the hood compartment of the vehicle 10 through the hood cover 220. As shown in FIG. 11, the mounting aperture 236 extends through the forward surface 222 of the hood cover 220. In various embodiments, the mounting aperture 236 extends through at least one of the forward surface 222, the intermediate surface 224, or the rearward surface 226. In some embodiments, the mounting aperture 236 defines a plurality of features (e.g., circular profiles, etc.) shaped to receive a fastener to couple elements to the hood cover 220. In other embodiments, the hood cover 220 defines a plurality of first apertures configured to receive the plurality of fasteners to couple the elements to the hood cover 220 (e.g., when the mounting aperture 236 does not include the plurality of features configured to receive the plurality of fasteners, etc.).

As shown in FIGS. 7 and 9, the hood assembly 200, includes a tray, (e.g., a compartment, a shelf, etc.), shown as hood tray 240, coupled to the hood cover 220 to align the hood tray 240 with the tray aperture 230. The hood tray 240 may be coupled to the inside surface of the hood cover 220 such that the hood tray 240 is positioned within the hood compartment of the vehicle 10. In other embodiments, the hood tray 240 may be coupled to other elements of the body 20 and/or the frame 12 to align the hood tray 240 with the tray aperture 230. The hood tray 240 is configured to support miscellaneous items and gear associated with the vehicle 10 and/or the operator of the vehicle 10. The hood tray 240 defines a compartment (e.g., a storage space, etc.), shown as tray compartment 242, directed towards the tray aperture 230 and configured to receive the miscellaneous items and gear supported by the hood tray 240 through the tray aperture 230. By way of example, the tray compartment 242 may be configured to receive and store a belt changing tool that is configured to assist the operator of the vehicle 10 with changing the track of the rear tractive assembly 56 of the vehicle 10 such that the operator may access the belt changing tool while operating the vehicle 10 (e.g., while operating the vehicle 10 in a remote environment, while operating the vehicle 10 far away from a repair shop, etc.).

As shown in FIG. 9, the hood tray 240 includes an extrusion (e.g., a bump, a mound, etc.), shown as tray bump 244, positioned at a bottom of the hood tray 240 and extending upwards into the tray compartment 242. The tray bump 244 may separate the tray compartment 242 into sub-compartments (e.g., a first sub-compartment, a second sub-compartment, etc.). The tray bump 244 may allow for the operator of the vehicle 10 to organize the miscellaneous items and gear supported by the hood tray 240 in tray compartment 242. By way of example, the operator may place a first item in the first sub-compartment of the hood tray 240 and a second item in the second sub-compartment of the hood tray 240 that the operator wants to keep separate from the first item. In some embodiments, the hood tray 240 includes a plurality of the tray bumps 244 separating the tray compartment 242 into a plurality of sub-compartments.

As shown in FIG. 9, the hood tray 240 defines a plurality of second apertures, shown as tray apertures 246, extending through the hood tray 240. The tray apertures 246 are configured to allow for fluid contained in the tray compartment 242 to drain out of the tray compartment 242 through the hood tray 240. By way of example, the miscellaneous items and gear contained within the tray compartment 242 may be covered by an amount of snow. As the snow increases in temperature, the snow may melt, forming water positioned within the tray compartment 242 that may drain out of the tray compartment 242 through the tray apertures 246 such that the water is drained away from the miscellaneous items and gear contained within the tray compartment 242. In some embodiments, the hood tray 240 may define at least one of the tray apertures 246 for each of the sub-compartments defined by the tray bumps 244 such that fluids may be drained from each of the sub-compartments through the at least one of the tray apertures 246.

As shown in FIGS. 4, 7-9, and 12-14, the vehicle 10 includes a mounting assembly (e.g., a display support assembly, a screen mount assembly, etc.), shown as display mounting assembly 300, coupled to the hood cover 220, configured to receive and support a display (e.g., a GPS device, a navigation device, a screen device, etc.), shown as display device 400, and configured to selectively cover the tray compartment 242 of the hood tray 240. The display device 400 includes a display (e.g., a screen, a visual interface, etc.), shown as display 402, and is configured to provide visual information to the operator of the vehicle 10 via the display 402. The display device 400 also includes a bezel (e.g., a frame, a grooved ring, etc.), shown as display bezel 404, surrounding the display 402. The display bezel 404 holds the display 402 in position. In some embodiments, the display bezel 404 is positioned lower than (e.g., offset downward from, etc.) the display 402 such that the display bezel 404 is not flush with the display 402.

The display mounting assembly 300 is configured to position the display device 400 in an orientation to allow for materials (e.g., snow, water, debris, etc.) that are deposited on the display 402 of the display device 400 to shed off of (e.g., fall off of, be removed from, etc.) the display 402 of the display device 400 to keep the display 402 of the display device 400 clear from obstruction. As a result, the operator may continue to utilize the display device 400 while operating the vehicle 10 in conditions that would otherwise cause the materials to accumulate on the display 402 of the display device 400. By way of example, the operator may continue to utilize the display device 400 while operating the vehicle 10 in deep snow conditions that may cause snow to be deposited on the display 402 of the display device 400 since the snow deposited on the display 402 of the display device will shed off of the display 402 of the display device 400.

In some embodiments, the display device 400 includes a speaker (e.g., an audio output element, etc.) and the display device 400 is configured to provide audio information to the operator of the vehicle 10 via the speaker. In some embodiments, the display device 400 includes a microphone (e.g., an audio input element, etc.) and the display device 400 is configured to receive audio information from the operator of the vehicle 10 via the microphone. By way of example, the display device 400 may be configured to display information associated with the operation of the vehicle 10. The display device 400 may be configured to receive data from the sensors 90 and/or the vehicle controller 100 associated with the operation of the vehicle 10 and operate the display 402 to display graphical user interfaces associated with the data to the operator of the vehicle 10. The graphical user interfaces may be associated with a speed of the vehicle 10, a range and/or fuel level of the vehicle 10, a location of the vehicle 10, an incline of the vehicle 10, etc. In some embodiments, the display device 400 of the vehicle 10 may be configured as a wireless display device configured to communicate with display devices of other vehicles (e.g., vehicles other than the vehicle 10, etc.). By way of example, during an excursion that includes multiple of the vehicles 10, the display devices 400 of each of the vehicles 10 may communicate with each other via a wireless network to provide interfaces that include a location of each of the vehicles 10 to the operators of the vehicles 10 and/or facilitate communication between the operators of the vehicles 10.

As shown in FIGS. 4, 7-9, and 12-14, the display mounting assembly 300 is configured as a standing display mounting assembly that positions the display 402 of the display device 400 at an angle that is optimal for the operator of the vehicle 10 when the operator is standing in the occupant seating area 30. By way of example, while operating the vehicle 10 in certain conditions (e.g., on a rough trail, through deep snow, etc.), the operator of the vehicle 10 may prefer to stand in the occupant seating area 30 (e.g., to reduce a shock on the body of the occupant, to see above certain objects, etc.). By angling the display 402 of the display device 400 at the angle that is optimal for the operator of the vehicle 10 when the operator is standing in the occupant seating area 30, the display mounting assembly 300 may make it easier for the operator to receive information from the display 402 while the operator is standing in the occupant seating area 30. In other embodiments, the display mounting assembly 300 may be configured as a seated display mounting assembly that positions the display 402 of the display device 400 at an angle that is optimal for the operator of the vehicle 10 when the operator is sitting in the occupant seating area 30 (e.g., sitting on the operator seat 32, etc.).

In still other embodiments, the display mounting assembly 300 is configured to position the display 402 of the display device 400 at a first angle that is optimal for the operator of the vehicle 10 when the operator is standing in the occupant seating area 30 and position the display 402 of the display device 400 at a second angle that is optimal for the operator of the vehicle 10 when the operator is sitting in the occupant seating area 30. By way of example, the display mounting assembly 300 may be adjustable between a first position that positions the screen of the display device 400 at the first angle and a second position that positions the screen of the display device 400 at the second angle.

According to an exemplary embodiment, the display mounting assembly 300 extends upward into the hood trough 228 defined by the hood cover 220. By extending upward into the hood trough 228, the display mounting assembly 300 may prevent material (e.g., snow, water, etc.) deposited on top of the display mounting assembly 300 from accumulating (e.g., gathering, etc.) within the hood trough 228 on top of the display mounting assembly 300, which could obscure the display 402 of the display device 400. By extending upward into the hood trough 228, the display mounting assembly 300 may allow for the material deposited on top of the display mounting assembly 300 to shed off of (e.g., move off of, fall off of, etc.) the display mounting assembly 300 into portions of the hood trough 228 positioned proximate the display mounting assembly 300 such that the material does not remain positioned on top of the display mounting assembly 300 and obscure the display 402 of the display device 400.

As shown in FIGS. 7 and 9-14, the display mounting assembly 300 includes a base assembly (e.g., a base bracket assembly, etc.), shown as mounting base assembly 308, coupled to the hood cover 220 and configured to receive and support the display device 400. The mounting base assembly 308 may be configured to extend through the mounting aperture 236 of the hood cover 220 when the display mounting assembly 300 is coupled to the hood cover 220. As shown in FIGS. 9-14, the mounting base assembly 308 includes a first body (e.g., a first bracket, etc.), shown as mounting base body 310, coupled to the hood cover 220 and configured to receive the display device 400. The mounting base body 310 defines a display cavity 312 configured to receive the display device 400 when the display mounting assembly 300 supports the display device 400.

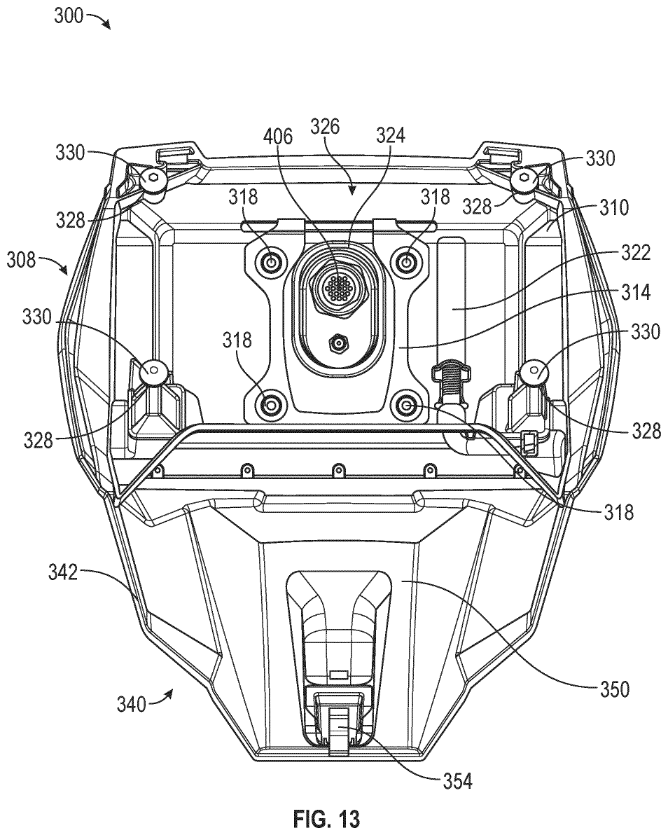

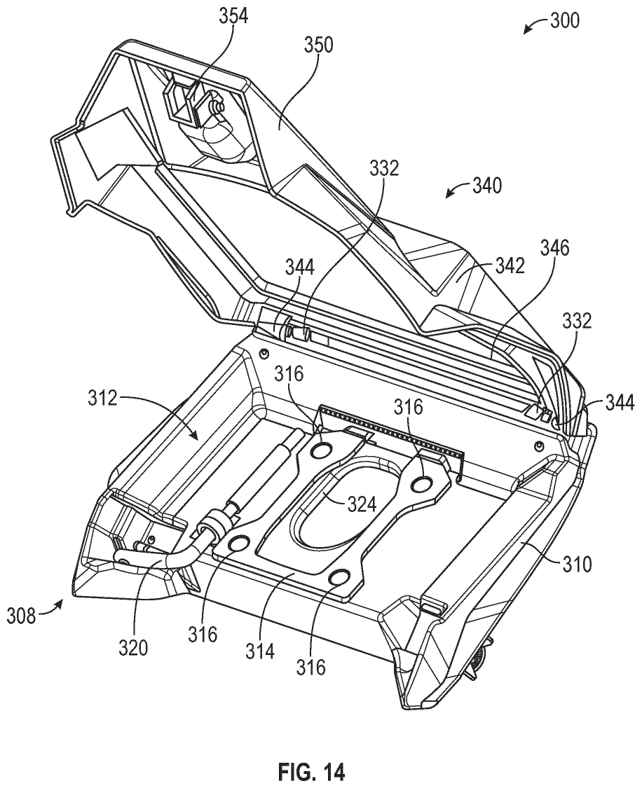

As shown in FIG. 14, the mounting base assembly 308 includes a spacer (e.g., a mounting pedestal, a mounting gasket, etc.), shown as display spacer 314, configured to selectively interface with the display device 400 to facilitate removably coupling the display device 400 to the mounting base assembly 308. When the display device 400 is coupled to the mounting base assembly 308, the display spacer 314 may be positioned between the display device 400 and the mounting base body 310 to cushion the display device 400 relative to the mounting base body 310. By way of example, the display spacer 314 may be formed out of a resilient material (e.g., rubber, foam, etc.) that cushions the display device 400 relative to a remainder of the mounting base assembly 308. As shown in FIGS. 13 and 14, the display spacer 314 is positioned on a top surface of the mounting base body 310 between the display device 400 and the mounting base body 310 and wraps around the mounting base body 310 to a bottom surface of the mounting base body 310 to prevent removal of the display spacer 314.

As shown in FIG. 14, the mounting base body 310 defines a plurality of third apertures, shown as display mounting apertures 316, configured to align with a plurality of fourth apertures of the display device 400 to selectively receive a plurality of first fasteners (e.g., bolt, screw, rivet, nail, anchor, etc.), shown as display fasteners 318, to removably couple the display device 400 to the mounting base body 310 and, thereby, the display device 400 to the vehicle 10. As shown in FIG. 14, the display mounting apertures 316 extend through the display spacer 314 such that the display fasteners 318 extend through a first portion of the display spacer 314 positioned below the mounting base body 310, through the mounting base body 310, through a second portion of the display spacer 314 positioned above the mounting base body 310, and into the fourth apertures of the display device 400 to couple the display device 400 and the display spacer 314 to the mounting base body 310.

In some embodiments, the display mounting apertures 316 are configured as slots to facilitate sliding or manipulating the alignment of the display device 400 relative to the mounting base body 310 to accommodate manufacturing tolerances during installation of the display to the mounting base body 310. In other embodiments, the mounting base body 310 is configured to selectively interface with the display device 400 using other methods (e.g., a sliding interface, a snap fit interface, etc.) to removably couple the display device 400 to the mounting base body 310.

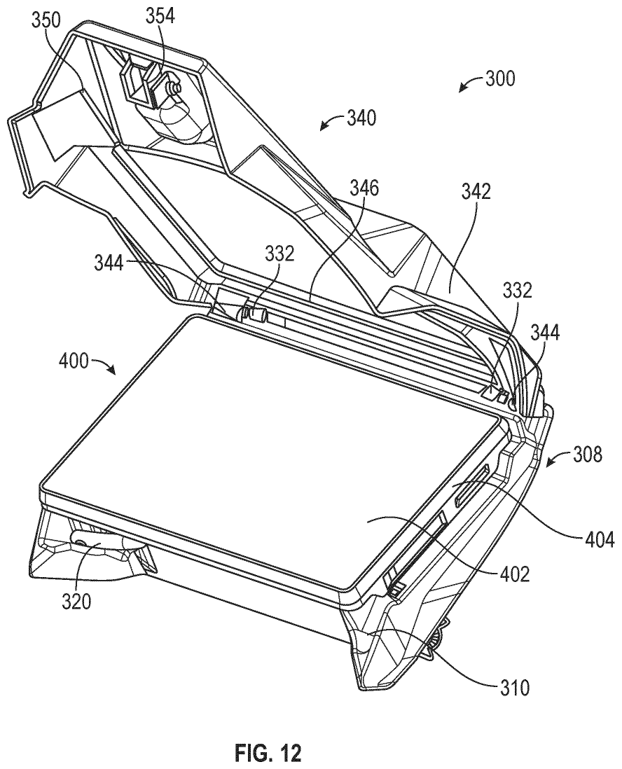

As shown in FIGS. 12 and 14, the mounting base assembly 308 includes a conduit, shown as wiring conduit 320, configured to receive a wire. When the display device 400 is coupled to the mounting base assembly 308, a wire may be provided through the wiring conduit 320 and coupled to the display device 400. By way of example, the wiring conduit 320 may receive a power cable electrically coupled to a battery of the vehicle 10 that may supply electrical power from the battery of the vehicle 10 to the display device 400. In some embodiments, the wiring conduit 320 is configured to receive a wire harness associated with the display device 400. By way of example, the wiring conduit 320 may be configured to receive a wire harness that includes a power cable, a sensor cable (e.g., coupling the display device 400 to sensors of the vehicle 10, etc.), and other cables configured to connect between elements of the vehicle 10 and the display device 400 (e.g., between the prime mover 52 and the display device 400, between the energy storage 54 and the display device 400, to the vehicle controller 100, etc.).

As shown in FIGS. 13, the mounting base body 310 defines a channel, shown as wiring conduit channel 322, configured to receive the wiring conduit 320. The wiring conduit channel 322 may be configured to allow for the wiring conduit 320 to be positioned between the display device 400 and the mounting base body 310 of the mounting base assembly 308 when the display device 400 is coupled to the mounting base assembly 308 such that the wiring conduit 320 can reach an input positioned on a back surface of the display device 400 (e.g., a back surface of the display device 400 opposite the display 402, etc.).

As shown in FIG. 13, the mounting base body 310 defines a third aperture, shown as display cooling aperture 324, configured to align with a cooling outlet 406 (e.g., a cooling vent, a cooling fan, etc.) of the display device 400 when the display device 400 is coupled to the mounting base assembly 308. The display cooling aperture 324 may allow for the display device 400 to vent hot air out of the cooling outlet 406 and through the display cooling aperture 324 to cool the display device 400. In some embodiments, the display cooling aperture 324 is configured to align with an inlet of the display device 400 when the display device 400 is coupled to the mounting base assembly 308. By way of example, the display cooling aperture 324 may be configured to align with a connector of the display device 400 configured to receive a cable (e.g., a sensor cable, a power cable, etc.) such that the cable can extend through the display cooling aperture 324 to the connector of the display device 400 when the display device 400 is coupled to the mounting base assembly 308. By way of another example, the display cooling aperture 324 may be configured to align with an air intake of the display 402 configured to intake air used to cool the display device 400 such that the display device 400 can intake air through the display cooling aperture 324 into the air intake when the display device 400 is coupled to the mounting base assembly 308.

In some embodiments, the display cooling aperture 324 of the mounting base body 310 aligns with the mounting aperture 236 of the hood cover 220. As a result, when the display device 400 is coupled to the mounting base assembly 308, the cooling outlet 406 may align with the display cooling aperture 324 and the mounting aperture 236 to allow for the display device 400 to vent hot air out of the cooling outlet 406 and though the display cooling aperture 324 and the mounting aperture 236 to cool the display device 400. In some embodiments, the inlet of the display device 400 may align with the display cooling aperture 324 and the mounting aperture 236.

As shown in FIG. 13, the mounting base body 310 includes a coupling interface, shown as coupling interface 326, configured to interface with the hood cover 220 to couple the mounting base body 310 to the hood cover 220. In some embodiments, the coupling interface 326 includes a plurality of standoffs configured to angle the display 402 of the display device 400 at the optimal angle for the operator of the vehicle 10 when the display device 400 is coupled to the mounting base assembly 308 (e.g., the optimal angle for the operator standing in the occupant seating area 30, the optimal angle for the operator sitting on the operator seat 32 in the occupant seating area 30, etc.).

As shown in FIG. 13, the coupling interface 326 defines a plurality of fourth apertures, shown as coupling apertures 328, configured to align with the mounting aperture 236 to selectively receive a plurality of second fasteners, shown as coupling fasteners 330, to removably couple the mounting base body 310 to the hood cover 220. In other embodiments, the coupling apertures 328 are configured to align with the plurality of first apertures defined by the hood cover to receive the coupling fasteners 330 to removably couple the mounting base assembly 308 to the hood cover 220 (e.g., when the mounting aperture 236 does not define the features shaped to receive fasteners, etc.). In still other embodiments, the coupling interface 326 is configured to selectively interface with the hood cover 220 using other methods (e.g., a sliding interface, a snap fit interface, etc.) to removably couple the mounting base assembly 308 to the hood cover 220.

As shown in FIGS. 12 and 14, the mounting base assembly 308 includes a first hinge portion (e.g., a first pivot interface, a first hinge element, a first hinging body, etc.), shown as a mounting hinge portion 332, coupled to a forward end of the mounting base body 310. The mounting hinge portion 332 may be positioned forward of the display cavity 312. In other embodiments, the mounting hinge portion 332 is coupled to a rearward end of the mounting base body 310, a left side of the mounting base body 310, or a right side of the mounting base body 310. In some embodiments, the mounting base assembly 308 includes a plurality of the mounting hinge portions 332.

As shown in FIGS. 7-10 and 12-14, the display mounting assembly 300 includes a cover (e.g., an integrated cover, a lid assembly, etc.), shown as display cover assembly 340, pivotably coupled to the mounting base assembly 308 via the mounting hinge portions 332 and configured to selectively cover the tray compartment 242. According to an exemplary embodiment, the display cover assembly 340 is configured to selectively cover a portion of the display device 400. The display cover assembly 340 may be positioned in a raised orientation (e.g., a first orientation, a first configuration, an open orientation, etc.) where the display cover assembly 340 does not cover the display device 400 and the tray compartment 242 or a closed orientation (e.g., a lowered orientation, a second configuration, a second orientation, etc.) where the display cover assembly 340 covers the tray compartment 242 and at least a portion of the display device 400. In the raised orientation, the display cover assembly 340 may allow for the display device 400 to be removed from the display cavity 312 and/or allow access to the tray compartment 242. In the closed orientation, the display cover assembly 340 may prevent the display device 400 from being removed from the display cavity 312 and/or prevent access to or enclose the tray compartment 242.

As shown in FIGS. 8-10 and 12-14, the display cover assembly 340 includes a second body (e.g., a second bracket, etc.), shown as display cover body 342, configured to selectively cover the tray compartment 242 and the display bezel 404 of the display device 400. By way of example, when the display cover assembly 340 is in the raised orientation, the display cover body 342 may allow access to (e.g., not cover, etc.) the tray compartment 242 and/or the display bezel 404 of the display device 400 and when the display cover assembly 340 is in the lowered orientation, the display cover body 342 may prevent access to (e.g., cover, etc.) the tray compartment 242 and/or the display bezel 404 of the display device 400. According to an exemplary embodiment, a peripheral sidewall of the display cover body 342 extends from the display aperture 346 at an outwardly and downwardly sloping angle.

As shown in FIGS. 12 and 14, the display cover assembly 340 includes a second hinge portion (e.g., a second pivot interface, a second hinge element, a second hinging body, etc.), shown as cover hinge portion 344, coupled to a forward end of the display cover body 342 and configured to pivotably couple to the mounting hinge portions 332 to pivotably couple the display cover assembly 340 to the mounting base assembly 308. The cover hinge portion 344 may be positioned on the forward edge of the display cover assembly 340 to align with the mounting hinge portion 332 positioned on the forward edge of the mounting base body 310. In other embodiments, the cover hinge portion 344 is coupled to a rearward end of the display cover body 342, a left side of the display cover body 342, or a right side of the display cover body 342 to align with the mounting hinge portion 332 based on the position of the mounting hinge portion 332 on the mounting base body 310. In some embodiments the display cover assembly 340 includes a plurality of the cover hinge portions 344 and each of the cover hinge portions 344 are configured to pivotably couple to one of the mounting hinge portions 332 to couple the display cover assembly 340 to the mounting base assembly 308.

According to an exemplary embodiment, the cover hinge portion 344 is removably coupled to the mounting hinge portion 332 to allow for the display cover assembly 340 to be removed from the mounting base assembly 308. In some embodiments, the cover hinge portion 344 is configured to decouple from the mounting hinge portions 332 when a force applied to the display cover assembly 340 is above a predetermined threshold such that the cover hinge portion 344 decouples from the mounting hinge portions 332 prior to a failure of an element of the display mounting assembly 300 (e.g., prior to a failure of the cover hinge portion 344 or the mounting hinge portion 332, prior to a failure of the mounting base body 310, prior to a failure of the display cover body 342, etc.). By way of example, the cover hinge portion 344 may be configured to decouple from the mounting hinge portions 332 when a force above the predetermined threshold (e.g., a force threshold, etc.) is applied to the display cover assembly 340 in the longitudinal direction when the display cover assembly 340 is in the raised orientation to prevent the failure of the cover hinge portion 344 and/or the mounting hinge portions 332.

As shown in FIGS. 8-10, 12, and 14, the display cover body 342 defines a fourth aperture, shown as display aperture 346, configured to align with the display 402 of the display device 400 when the display cover assembly 340 is in the lowered orientation. The display aperture 346 may allow for the operator of the vehicle 10 to see (e.g., visualize, etc.) the display 402 of the display device 400 through the display aperture 346 when the display cover assembly 340 is in the closed orientation. In some embodiments, the display cover assembly 340 includes a transparent cover (e.g., a pane, a window, etc.) configured to cover the display aperture 346 while allowing for the operator of the vehicle 10 to see the display 402 of the display device 400 through the display aperture 346 and the transparent cover when the display cover assembly 340 is in the closed orientation. The transparent cover may protect the display 402 of the display device 400 when the display cover assembly 340 is in the closed orientation.

According to an exemplary embodiment, a first cross sectional area (e.g., a first cross sectional footprint, etc.) of the display aperture 346 may be smaller than a second cross sectional area (e.g., a second cross sectional footprint, etc.) of the display device 400 such that the display bezel 404 of the display device 400 is positioned below an edge of the display cover body 342 defining the display aperture 346. As a result, the display cover assembly 340 may allow for the operator of the vehicle 10 to see the display 402 of the display device 400 through the display aperture 346 while preventing the display device 400 from being unintendedly removed from the display cavity 312 when the display cover assembly 340 is in the closed orientation. In other embodiments, the first cross sectional area of the display aperture 346 is the same size or larger than the second cross sectional area of the display device 400 and the display is held in the display cavity 312 using other means (e.g., the display fasteners 318, etc.).

As shown in FIG. 8, a first portion of a top surface of the display cover body 342 proximate the display aperture 346 (e.g., a first upward facing surface, etc.), shown as display cover surface 348, is substantially flush with the display 402 of the display device 400 when the display cover assembly 340 is in the closed orientation to prevent accumulation of materials around the display aperture 346 that may cover an outside portion of the display 402. When the display cover surface 348 of the display cover body 342 is flush (e.g., substantially flush, etc.) with the display 402, material on the display 402 may be shed front the display 402 onto the display cover surface 348 without accumulating above the display bezel 404 positioned around the outside of the display 402 (e.g., at an interface between the display 402 and the display cover surface 348, etc.). By way of example, if the display cover body 342 included a raised lip around the display aperture 346 or the display bezel 404 was exposed between the display 402 and the display cover body 342 when the display cover assembly 340 is in the lowered orientation, material may accumulate at the interface between the display 402 and the display cover body 342, which could obstruct the display 402. In other embodiments, the display cover surface 348 is positioned below the display 402 of the display device 400 when the display cover assembly 340 is in the closed orientation. When the display cover surface 348 is positioned below the display 402, material on the display 402 may be shed off of the display 402 onto the display cover assembly 340 without accumulating at the interface between the display 402 and the display cover assembly 340.

As shown in FIGS. 8 and 12-14, the display cover body 342 includes a cover portion (e.g., a tray cover body, etc.), shown as tray cover portion 350, configured to cover the tray compartment 242 when the display cover assembly 340 is in the closed orientation. The tray cover portion 350 is positioned above the tray compartment 242 when the display cover assembly 340 is in the lowered position to prevent access to the tray compartment 242. In some embodiments, the tray cover portion 350 may include a sealing element (e.g., a sealing foam, a rubber o-ring, a sealing gasket, etc.) configured to seal between the tray cover portion 350 and the hood cover 220 when the display cover assembly 340 is in the lowered orientation. The sealing element may prevent liquids from entering the tray compartment 242 between the tray cover portion 350 and the hood cover 220 when the display cover assembly 340 is in the lowered orientation.

As shown FIG. 8, a second portion of the top surface of the display cover body 342 (e.g., the top surface of the tray cover portion 350, a second upward facing surface, etc.), shown as tray cover surface 352, is orientated substantially parallel (e.g., within 10 degrees, within 5 degrees, within 1 degree, etc.) of the display cover surface 348. According to the exemplary embodiment shown in FIG. 8, the tray cover surface 352 is vertically offset (i.e., downward) from the top surface of the display cover body 342. In some embodiments, the tray cover surface 352 is coplanar with the display cover surface 348. In some embodiments, the tray cover surface 352 is flush (e.g., coincident, etc.) with the display cover surface 348. The orientation of the tray cover surface 352 and the display cover surface 348 may be configured to prevent material from accumulating between the tray cover surface 352 and the display cover surface 348, which could obstruct the display 402 of the display device 400 when the display device 400 is received by the display mounting assembly 300.

As shown in FIG. 8, when the display cover assembly 340 is in the lowered position, the display cover surface 348, the tray cover surface 352, and the display 402 are positioned above the intermediate surface 224 defining the hood trough 228. Since the display cover surface 348, the tray cover surface 352, and the display 402 are positioned above the intermediate surface 224, material that is deposited on top of the display cover surface 348, the tray cover surface 352, and the display 402 may be shed off of the display cover surface 348, the tray cover surface 352, and the display 402 into the hood trough 228 and/or onto the intermediate surface 224. As a result, the material that is deposited on top of the display cover surface 348, the tray cover surface 352, and the display 402 may not accumulate on the display cover surface 348, the tray cover surface 352, and the display 402, which could obstruct the display 402.

As shown in FIGS. 8 and 12-14, the display cover assembly 340 includes a latch assembly (e.g., a latch device, a latch mechanism, retainer, etc.), shown as cover latch assembly 354 configured to interface with the tray latch member 234 to selectively couple the display cover assembly 340 to the hood cover 220 when the display cover assembly 340 is in the lowered orientation. The cover latch assembly 354 may include a latched configuration (e.g., a locked configuration, etc.) where the cover latch assembly 354 engages the tray latch member 234 to couple the display cover assembly 340 to the hood cover 220 and prevent the display cover assembly 340 from pivoting relative to the mounting base assembly 308. The cover latch assembly 354 may also include an unlatched configuration (e.g., an unlocked configuration, etc.) where the cover latch assembly 354 does not engage the tray latch member 234 to allow the display cover assembly 340 to pivot relative to the mounting base assembly 308. As shown in FIG. 8, the cover latch assembly 354 includes a handle (e.g., an interface member, etc.), shown as latch handle 356, configured to be operated by the operator of the vehicle 10 to transition the cover latch assembly 354 from the latched configuration to the unlatched configuration or vise versa. By way of example, the cover latch assembly 354 may be transitioned from the latched configuration where the cover latch assembly 354 is engaged with tray latch member 234 to the unlatched configuration when the latch handle 356 is lifted upward. In some embodiments, the cover latch assembly 354 defaults to the latched configuration unless the latch handle 356 is being operated to place the cover latch assembly 354 in the unlatched configuration. In other embodiments, the cover latch assembly 354 is configured to interface with the hood cover 220 to in selectively the display cover assembly 340 to the hood cover 220 when the display cover assembly 340 is in the lowered orientation (e.g., in orientations of the hood cover 220 that do not include the tray latch member 234, etc.).

### Retrofit Solution

According to an exemplary embodiment, the display mounting assembly 300 can be manufactured as a modular or retrofit kit configured to provide a retrofit solution for converting an existing vehicle with a display mounting assembly that is not configured to shed materials from the display 402 of the display device 400 into a vehicle with the display mounting assembly 300 configured to shed materials form the display 402 of the display device 400. In some embodiments, the coupling interface 326 is designed and manufactured to integrate into an existing body of various different vehicles. Therefore, installing the display mounting assembly 300 into an existing vehicle may provide the ability to shed materials from the display 402 of the display device 400 installed into the existing vehicle without requiring the purchase of a new vehicle. In some embodiments, the coupling interface 326 may be designed and manufactured to integrate into existing vehicles and new vehicles such that different configurations of the display mounting assembly 300 do not need to be designed and manufactured based on the vehicle that the display mounting assembly 300 will be installed into. In various embodiments, the display mounting assembly 300 is designed and manufactured to integrate into vehicles that are not configured to receive the display device 400. Therefore, installing the display mounting assembly 300 into an existing vehicle may provide the ability to receive the display device 400.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, the hood assembly 200, the display mounting assembly 300, etc.) as shown in the various exemplary embodiments is illustrative only. Additionally, any element disclosed in one embodiment may be incorporated or utilized with any other embodiment disclosed herein.

1. A mounting assembly for coupling a display device to a snowmobile, the mounting assembly comprising:
a base configured to couple to a body component of the snowmobile, the base defining a cavity configured to receive the display device; and
a cover pivotably coupled to the base, the cover configured to pivot between an open position and a closed position, the cover defining an aperture configured to align with a display of the display device when the cover is in the closed position, the cover configured to cover a portion of the display device when in the closed position such that the display device is disposed between the base and the cover.

2. The mounting assembly of claim 1, wherein an upward facing surface of the cover is configured to be flush with the display of the display device when the cover is in the closed position such that material deposited on the display sheds off of the display toward the upward facing surface of the cover.

3. The mounting assembly of claim 2, wherein the base is configured to orient the display of the display device at an angle that is optimal for an operator that is standing while operating the snowmobile.

4. The mounting assembly of claim 1, wherein the cover is pivotably coupled to the base at a forward end of the base.

5. The mounting assembly of claim 4, wherein the cover is configured to decouple from the base when a force is applied to the cover that is above a predetermined threshold.

6. The mounting assembly of claim 1, wherein the cover extends rearward of the base when cover is the closed position.

7. The mounting assembly of claim 6, further comprising the body component, wherein the body component defines a compartment, and wherein the cover encloses the compartment when in the closed position such that access into and out of the compartment is restricted.

8. The mounting assembly of claim 7, wherein cover includes a retainer configured to engage a portion of the body component to hold the cover in the closed position.

9. The mounting assembly of claim 1, further comprising the body component, wherein the body component defines a recess, wherein the base is disposed within the recess, and wherein the display of the display device is positioned above a surface of the body component when the display device is received by the base.

10. The mounting assembly of claim 1, wherein an edge of the aperture is configured to be flush with the display of the display device when the cover is in the closed position.

11. The mounting assembly of claim 10, wherein a peripheral wall of the cover extending from the edge extends therefrom at a downward sloping angle.

12. The mounting assembly of claim 1, wherein the mounting assembly is configured as a modular kit configured to be coupled to the body component of an existing snowmobile to retrofit the mounting assembly into the existing snowmobile.

13. A snowmobile comprising:
a frame;
a body coupled to the frame, an upward facing surface of the body defining a mounting interface; and
a mounting assembly disposed along the mounting interface, the mounting assembly configured to receive a display device, the mounting assembly extending upward from the mounting interface such that a display of the display device is positioned above the upward facing surface of the body when the display device is received by the mounting assembly.

14. The snowmobile of claim 13, wherein the mounting assembly comprises:
a base configured to couple to the mounting interface, the base defining a cavity configured to receive the display device; and
a cover coupled to the base, the cover defining a display aperture configured to align with the display of the display device when the display device is received by the mounting assembly.

15. The snowmobile of claim 14, wherein an upper edge of the display aperture is configured to be flush with the display such that material deposited on the display sheds off of the display.

16. The snowmobile of claim 14, wherein the cover is configured to decouple from the base when a force is applied to the cover that is above a predetermined threshold.

17. The snowmobile of claim 14, wherein the cover is pivotably coupled to the cover.

18. The snowmobile of claim 17, wherein the body defines a compartment positioned rearward of the mounting interface, and wherein the cover is configured to enclose the compartment such that access into and out of the compartment is selectively restricted.

19. A mounting assembly for coupling a display device to a vehicle, the mounting assembly comprising:
a base configured to couple to a body component of the vehicle, the base defining a cavity configured to receive the display device; and
a cover coupled to the base, the cover defining an aperture configured to align with a display of the display device when the display device is received by the mounting assembly;
wherein an edge of the aperture is configured to be flush with the display such that material deposited on the display sheds off of the display; and
wherein a peripheral wall of the cover extending from the edge extends therefrom at a downward sloping angle.

20. The mounting assembly of claim 19, wherein the cover is configured to cover a compartment of the body component positioned rearward of the display device, and wherein cover includes a retainer configured to engage a portion of the body component to hold the cover in a closed position.
